(19) United States
(12) Patent Application Publication
(10) Pub. No.: US 2022/0126267 A1
(43) Pub. Date: Apr. 28, 2022

(54) CO-PYROLYZED SLUDGE BIOCHAR MODIFIED BY LANTHANUM CARBONATE, PREPARATION METHOD AND USE THEREOF

(71) Applicant: Guangzhou University, Guangzhou (CN)

(72) Inventors: Huayong Luo, Guangzhou (CN); Baiyou Liu, Guangzhou (CN); Hongwei Rong, Guangzhou (CN)

(21) Appl. No.: 17/567,924

(22) Filed: Jan. 4, 2022

Related U.S. Application Data
(63) Continuation of application No. PCT/CN2020/115064, filed on Sep. 14, 2020.

(30) Foreign Application Priority Data
Nov. 1, 2019 (CN) 201911059431.4

(51) Int. Cl. B01J 20/20; B01J 20/30; C02F 1/28; C02F 11/10

(52) U.S. Cl. CPC B01J 20/20; B01J 20/3078; B01J 20/3021; B01J 20/3071; B01J 20/3085; C02F 2101/105; C02F 11/10; B01J 2220/4825; B01J 2220/42; B01J 2220/4887; C02F 1/283

(57) ABSTRACT

The invention relates to a co-pyrolyzed sludge biochar modified by lanthanum carbonate, a preparation method and a use thereof. The method comprises: adding a co-pyrolyzed sludge biochar into a metal salt solution of lanthanum ions, heating and adding a carbonate solution until the pH is 8 to 9, and standing still at a constant temperature, and separating to obtain a co-pyrolyzed sludge biochar modified by lanthanum carbonate, the sludge biochar is prepared by co-pyrolysis of sludge and bamboo. The co-pyrolyzed sludge biochar modified by lanthanum carbonate prepared by the present invention can effectively adsorb and remove phosphate in water due to containing the lanthanum carbonate with strong affinity for anions and a larger specific surface area.

### CROSS REFERENCE TO RELATED APPLICATIONS

The present application is a Continuation application of PCT Application No. PCT/CN2020/115064 filed on Sep. 14, 2020, which claims the benefit of Chinese Patent Application No. 201911059431.4 filed on Nov. 1, 2019. All the above are hereby incorporated by reference in their entirety.

### TECHNICAL FIELD

The invention belongs to the field of water treatment, and particularly relates to a co-pyrolyzed sludge biochar modified by lanthanum carbonate, a preparation method and a use thereof.

### BACKGROUND

With the gradual increase of the treating ratio of urban sewage in China, the yield of urban sludge has gradually increased. Due to the huge volume of sludge and the problems of the presence of potentially toxic elements, microorganisms and many harmful organic substances in the sludge etc., how to safely deal with the sludge will become a very urgent issue in the process of urban development. Traditional treatment methods for urban sludge mainly include anaerobic digestion, landfilling and composting, etc. However, they are time-consuming and may have adverse effects on the environment due to the inherent characteristics of the sludge. In recent years, preparing sludge biochar by means of the use of sludge pyrolysis technology has become one of the research hotspots. On one hand, sludge biochar has stable properties and can fix heavy metals in wastes, thereby alleviating the adverse impact on the environment; on the other hand, biochar has abundant voids, larger specific surface area and a variety of surface functional groups, so that it has a broad application prospect in adsorption aspect.

At present, the use of adsorption technology to achieve effective removal and recovery of phosphorus in sewage has attracted widespread attention. Certain results have been obtained in the study on sludge biochar and its modified materials on the adsorption of phosphorus in sewage, however, there are few reports relating to the preparation and the performance of lanthanum carbonate-modified sludge biochar. Lanthanum carbonate, as a drug for the treatment of hyperphosphatemia, has a higher phosphorus removal effect than other lanthanum compounds, and has attracted more and more attention. At the same time, considering that the co-pyrolysis of many kinds of waste biomass may have a certain synergistic effect to improve the adsorption performance of biochar, this study uses sludge and bamboo as raw materials to prepare biochar by means of co-pyrolysis, and lanthanum carbonate is loaded on the surface of sludge biochar to enhance the adsorption capacity of modified biochar for phosphorus in water.

### SUMMARY OF THE INVENTION

A purpose of the present invention is to provide a preparation method of co-pyrolyzed sludge biochar modified by lanthanum carbonate. Co-pyrolysis using sludge and bamboo to prepare biochar has the advantages of wide sources of raw materials, low cost, environmental friendliness and reuse of resource. On one hand, the co-pyrolysis of bamboo and sludge to prepare biochar can effectively adjust the overall content of moisture in the sludge, improve the pyrolysis efficiency, and reduce the emission of nitrogen oxides and sulfur oxides produced during the pyrolysis process; on the other hand, the biochar prepared by co-pyrolysis can transform potentially toxic metals in the sludge from a weakly binding state into a more stable state, which enhances the immobilization of metals. At the same time, biochar has a large specific surface area and contains a large number of functional groups such as carboxyl and carbonyl groups etc., which provides a large number of attachment sites for lanthanum carbonate, thereby effectively improving the phosphorus removal effect of biochar. Relative to lanthanum hydroxide, lanthanum carbonate-modified biochar can reduce the effect of pH in the system on the phosphorus removal process and further improve the efficiency of phosphorus removal.

The purpose of the present invention is achieved through the technical solutions described below:

A preparation method of co-pyrolyzed sludge biochar modified by lanthanum carbonate comprises the following steps:

adding a co-pyrolyzed sludge biochar into a metal salt solution of lanthanum ions (La³⁺), heating and adding a carbonate solution until the pH is 8 to 9, and standing still at a constant temperature, and separating to obtain the co-pyrolyzed sludge biochar modified by lanthanum carbonate, the co-pyrolyzed sludge biochar is prepared by co-pyrolysis of sludge and bamboo.

Preferably, a preparation method of the co-pyrolyzed sludge biochar is: mixing bamboo and sludge at a mass ratio of 1:1, crushing with a pulverizer for 5 to 10 minutes, filtering through a sieve of 80 to 200 meshes, and pyrolyzing to obtain the co-pyrolyzed biochar.

Preferably, the pyrolysis is heating to 600° C. at a heating rate of 10 to 15° C./hour, maintaining for 1 hour at a constant temperature of 600° C., and then cooling to room temperature.

Preferably, a concentration of lanthanum ions in the metal salt solution is 0.1 to 0.5 mol/L.

Preferably, the metal salt solution of lanthanum ions is obtained by dissolving lanthanum nitrate hexahydrate in water and stirring for 2 hours to 6 hours.

Preferably, the ratio of the amounts of the co-pyrolyzed sludge biochar to lanthanum ions is 100 g:1 mol.

Preferably, the temperature for the heating is 30 to 50° C., the stirring rate is 400 to 800 rpm/min, the carbonate solution is a sodium carbonate solution with a concentration of 1 mol/L, and the standing still is standing still at 40 to 60° C. for 6 to 12 hours.

Preferably, the separation is washing for 3 to 5 times, centrifuging the solution at 3000 to 5000 rpm/min for 5 to 10 minutes, filtering, and drying at 40 to 60° C. for 36 to 48 hours.

A co-pyrolyzed sludge biochar modified by lanthanum carbonate prepared by the above-described method.

The co-pyrolyzed sludge biochar modified by lanthanum carbonate may be used in an adsorption of phosphate in water.

The present invention has the following beneficial effects:

The co-pyrolyzed sludge biochar modified by lanthanum carbonate of the present invention, has the following advantages:

(1) Sludge and bamboo are co-pyrolyzed to prepare biochar. Due to the higher water content of the sludge, it is co-pyrolyzed with bamboo having lower water content to adjust the overall moisture content, which reduces the cost of drying, and increases the pyrolysis efficiency.

(2) Sludge and bamboo are co-pyrolyzed to prepare biochar, which reduces the emission of nitrogen oxides and sulfur oxides produced during the pyrolysis process, and can transform the potentially toxic metals in the sludge from a weakly binding state to a more stable state at the same time.

(3) Modification of biochar by lanthanum carbonate can enhance the adsorption capacity of biochar of phosphorus in water, and reduce the influence of pH in the system on the phosphorus removal process.

(4) The preparation method of the present invention has simple operation and good adsorption effect. The prepared adsorbent material uses dehydrated sludge as a main raw material, is an environmentally friendly material, and has the characteristics of recycling waste and alleviating environmental pollution.

### BRIEF DESCRIPTION OF THE DRAWINGS

FIG. 1 is a flow chart of preparing co-pyrolyzed sludge biochar modified by lanthanum carbonate.

FIG. 2 is an SEM photograph of co-pyrolyzed sludge biochar modified by lanthanum carbonate.

FIG. 3 is a graph showing the influence of contacting time on the adsorption performance of co-pyrolyzed sludge biochar modified by lanthanum carbonate.

FIG. 4 is a graph showing the effect of the initial concentration of phosphate on the adsorption performance of co-pyrolyzed sludge biochar modified by lanthanum carbonate.

FIG. 5 is a graph showing the adsorption performance of co-pyrolyzed sludge biochar modified by lanthanum carbonate prepared at different La³⁺ concentrations.

FIG. 6 is a graph showing the effect of pH on the adsorption performance of co-pyrolyzed sludge biochar modified by lanthanum carbonate.

### DETAILED DESCRIPTION

The present invention will be described in detail below to ensure that those skilled in the art can implement it with reference to the description.

### Example 1

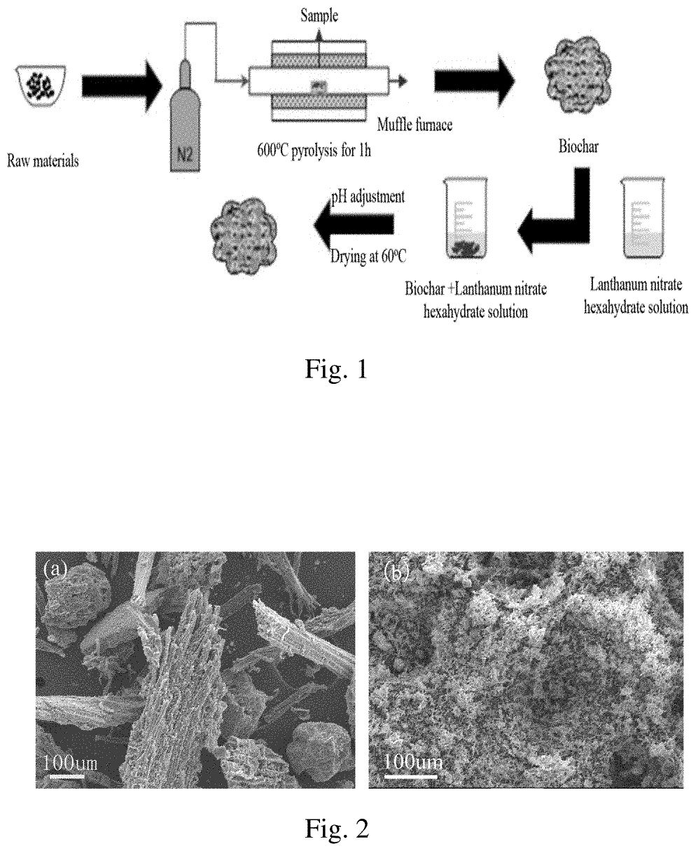

A preparation method of a co-pyrolyzed sludge biochar modified by lanthanum carbonate, includes the following steps (seeing FIG. 1 for the flow chart):

(1) At room temperature, the bamboo and the sludge was mixed at a mass ratio of 1:1, crushed with a pulverizer for 5 to 10 minutes, and filtered through an 80 to 200 meshes sieve, to obtain a mixed powder. The mixed powder was placed in a tube furnace, under the protection of N₂, heated to 600° C. at a heating rate of 10 to 15° C./hour, maintained constant at 600° C. for 1 hour, and cooled to room temperature, to obtain the co-pyrolyzed sludge biochar.

(2) A lanthanum nitrate hexahydrate was dissolved in ionized water to formulate a metal salt solution with a concentration of lanthanum ions of 0.1 mol/L, and the solution was stirred for 2 hours until the mixture is uniform.

(3) 0.5 g of the co-pyrolyzed sludge biochar obtained in step (1) was added into the metal salt solution prepared in step (2) to obtain 50 mL of a homogeneously mixed solution, and the solution was stirred for 12 hours until the mixture is uniform.

(4) The mixed solution obtained in step (3) was heated to 45° C. in a water bath, 1 mol/L sodium carbonate solution was slowly and uniformly dropped in simultaneously during stirring at 450 rpm/min, until the pH is adjusted to 8 to 9. Then, the solution was standing still at 60° C. for 6 hours. After cleaning with deionized water for 3 to 5 times, the solution was centrifuged at 3000 to 5000 rpm/min for 5 to 10 minutes, and then dried at 40 to 60° C. for 36 to 48 hours, so as to obtain the co-pyrolyzed sludge biochar modified by lanthanum carbonate.

Structure and Performance of Co-Pyrolyzed Sludge Biochar Modified by Lanthanum Carbonate

The scanning electron microscope photograph of the co-pyrolyzed sludge biochar modified by lanthanum carbonate prepared in Example 1 was shown in portion b in FIG. 2, and the SEM photograph of the unmodified co-pyrolyzed sludge biochar prepared by the same step was shown in portion a in FIG. 2. It can be seen that the unmodified co-pyrolyzed sludge biochar powder had a dense surface structure, unobvious pore structure, low degree of cavitation, and lower effective surface area; while the co-pyrolyzed sludge biochar modified by lanthanum carbonate had an obviously changed morphological structure, with a loose and porous surface morphology, and larger specific surface area (seeing Table 1), so that the adsorption sites increased, which was beneficial to improve its adsorption effect of phosphorus.

TABLE 1
BET specific surface area (S_{BET}) of biochar samples

| Sample | S_{BET} (m²/g) |
|---|---|
| unmodified co-pyrolyzed sludge biochar | 62.96 |
| co-pyrolyzed sludge biochar modified by | 275.23 |
| lanthanum carbonate | |

Effect of Contacting Time on the Adsorption Performance of Co-Pyrolyzed Sludge Biochar Modified by Lanthanum Carbonate

The co-pyrolyzed sludge biochar modified by lanthanum carbonate prepared in Example 1 was used in the adsorption study of phosphate in water, and the influence of contacting time on the adsorption performance was investigated. The ammonium molybdate spectrophotometric method was selected and used to determine the concentrations of phosphate in the water before and after adsorption, and the adsorption capacity was calculated by formula (1):

$${q}_{t} = \frac{( {C}_{o} - {C}_{t} ) \times V}{m} \qquad ( 1 )$$

wherein, qₜ is the average adsorption capacity per unit mass of adsorbent within time t, mg-P/g; Cₒ is the concentration of phosphate in the solution before adsorption, mg/L; Cₜ is the concentration of phosphate in the solution after adsorption for a period of t, mg/L; V is the volume of the phosphate solution, L; and m is the mass of the adsorbent, g.

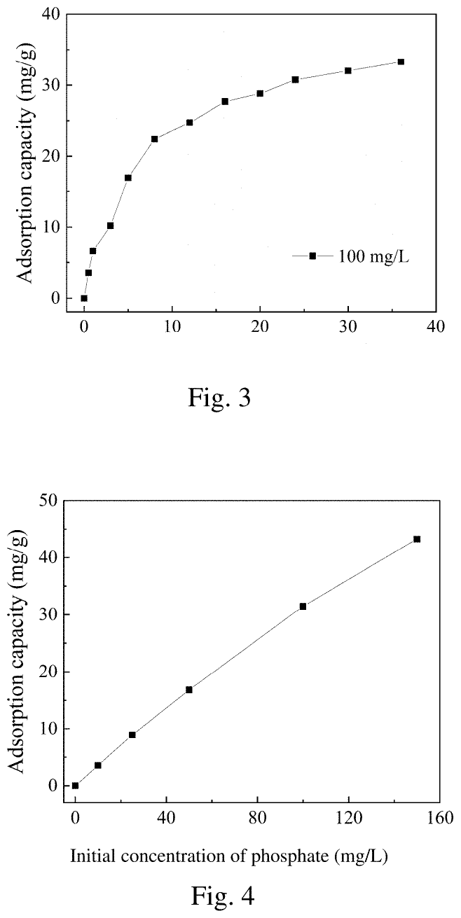

In the experiment on the effect of contacting time, 0.05 g of the co-pyrolyzed sludge biochar modified by lanthanum carbonate prepared in Example 1 was added into 20 mL of a phosphate salt solution with a pH of 5.5 and a concentration of 100 mg/L formulated with potassium dihydrogen phosphate, and the mixture was shaken at a constant temperature of 25° C. A certain volume of samples were taken at regular intervals to determine the adsorption capacity according to formula (1). The results were shown in FIG. 3. It can be seen that with the lengthening of the contacting time, the adsorption capacity of the co-pyrolyzed sludge biochar modified by lanthanum carbonate gradually increased until the adsorption equilibrium was reached. When the initial concentration of phosphate was 100 mg/L, the time required for biochar to reach adsorption equilibrium was 24 hours, and the corresponding adsorption capacity was 30.62 mg/g.

Effect of the Initial Concentration of Phosphate on the Adsorption Performance of Co-Pyrolyzed Sludge Biochar Modified by Lanthanum Carbonate

In order to examine the effect of the initial concentration of phosphate on the adsorption performance, 0.05 g of the co-pyrolyzed sludge biochar modified by lanthanum carbonate prepared in Example 1 was weighed and put into 20 mL of phosphate solutions with a pH of 5.5 and concentrations of 10, 25, 50, 100, and 150 mg/L, respectively, which were formulated with potassium dihydrogen phosphate. They were shaken at a constant temperature of 25° C., adsorbed for 24 hours, and then taken out to determine the adsorption capacities according to formula (1). The results were shown in FIG. 4. It can be seen that with the increase of the initial concentration of phosphate, the adsorption capacity of the co-pyrolyzed sludge biochar modified by lanthanum carbonate also increased therewith. The reason may be that the increase of the concentration of phosphate in the system may increase the coordination probability of phosphate radical with binding sites of the adsorbent, leading to an increase in adsorption performance Using the Langmuir model (the formula as followed), the maximum theoretical single-layer adsorption capacity was calculated as 59.8 mg/g (seeing Table 2), indicating that the prepared biochar has a certain potential in phosphorus removal aspect.

$${q}_{e} = \frac{{q}_{max} {k}_{L} {C}_{e}}{1 + {k}_{L} {C}_{e}}$$

in the formula: qₑ represents the adsorption capacity of phosphate at the equilibrium state of adsorption, mg/g; Ce represents the concentration of phosphate remaining in the solution at the equilibrium state of adsorption, mg/L; qₘₐₓ represents the theoretical value of the maximum adsorption capacity by the fitting analysis, mg/g; K_{L} represents the Langmuir constant, L/mg;

TABLE 2
Langmuir isotherm adsorption model parameters

| | | |
|---|---|---|
| Langmuir | K_{L} (L/mg) | 0.05 |
| | qₘₐₓ (mg/g) | 59.87 |
| | R² | 0.986 |

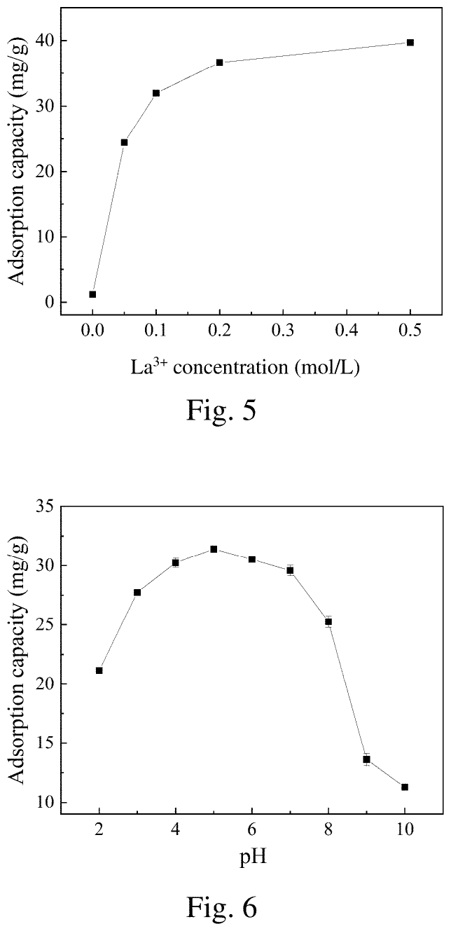

Adsorption Performance of Co-Pyrolyzed Sludge Biochar Modified by Lanthanum Carbonate Prepared with Different La³⁺ Concentrations
The concentration of lanthanum ions in step (2) was revised to 0, 0.05, 0.1, 0.2, and 0.5 mol/L, and the rest steps were same as those in Example 1. Each 0.05 g of the obtained co-pyrolyzed sludge was put into 20 mL of a phosphate solution with a pH of 5.5 and a concentration of 100 mg/L prepared by potassium dihydrogen phosphate, and the solution was oscillated at a constant temperature at 25° C., adsorbed for 24 hours, and then taken out to determine the adsorption capacity according to formula (1). The calculation results were shown in FIG. 5. It can be seen from the figure that as the concentration of La³⁺ was rising, the adsorption capacity of biochar increased therewith. The reason may be that the increase of the La³⁺ concentration allows a large number of functional groups such as carboxyl and carbonyl groups etc. in the biochar to load more lanthanum ions, thereby fixing and forming a large amount of lanthanum carbonate to improve the adsorption effect. It can be seen from FIG. 5 that as the concentration of lanthanum was gradually rising, the adsorption performance of biochar changed from a rapid-increasing state into slowly reaching a saturated equilibrium state.

### Effect of pH on the Adsorption Performance of Co-Pyrolyzed Sludge Biochar Modified by Lanthanum Carbonate

In order to explore the effect of initial pH on the adsorption performance, a phosphate solution with a concentration of 100 mg/L was weighed and formulated, and adjusted with 1 mol/L hydrochloric acid and sodium hydroxide to obtain a solution with a pH of 2 to 10. Then, 0.05 g of co-pyrolyzed sludge biochar modified with lanthanum carbonate was weighed, and added into 20 mL of phosphate solutions with different pH values respectively, oscillated at a constant temperature of 25° C., adsorbed for 24 hours, and taken out for determination of adsorption capacity according to formula (1). The results were shown in FIG. 6. It can be seen from the figure that the prepared biochar had a better adsorption capacity of phosphate under neutral and weakly acidic conditions, indicating that influence by pH reduced.
Comparison of Adsorption Performance of Co-Pyrolyzed Sludge Biochar Modified by Lanthanum Carbonate with Those of Other Biochar Materials
Table 3 compared the performances of new types of biochar adsorption materials for removing phosphate in water in recent years. It can be seen that the prepared biochar had a relatively higher adsorption capacity of phosphate in water.

TABLE 3
Comparison of the performances of biochar adsorption
materials for removing phosphate in water

| | | Initial | Saturated | |
|---|---|---|---|---|
| | | concentration | adsorption | |
| | Experimental | of phosphate | capacity | |
| Adsorbent | condition | (mg/L) | (mg-/g) | Reference documents |
| Dolomite- | pH = 4.5 | 100 | 18 | Li J, Li B, Huang H, et al. |
| modified | T = 25° C. | | | Removal of phosphate from |
| biochar | | | | aqueous solution by dolomite- |
| | | | | modified biochar derived |
| | | | | from urban dewatered sewage |
| | | | | sludge [J]. |
| | | | | Science of The Total |
| | | | | Environment. 2019, 687: |
| | | | | 460 to 469. |
| Magnesium | pH = 4 | 200 | 19.92 | Li R, Wang J J, Zhou B, et al. |
| oxide | T = 23° C. | | | Recovery of phosphate from |
| impregnated | | | | aqueous solution by magnesium |
| magnetic | | | | oxide decorated magnetic |
| biochar | | | | biochar and its potential as |
| | | | | phosphate-based fertilizer |
| | | | | substitute [J]. |
| | | | | Bioresource technology, 2016, |
| | | | | 215: 209-214 |
| Ce/Fe₃O₄ | pH = 6.12 | 75 | 18.75 | Wang L, Wang J, He C, et al. |
| modified | T = 25° C. | | | Development of rare earth |
| biochar | | | | element doped magnetic biochars |
| | | | | with enhanced phosphate |
| | | | | adsorption performance [J]. |
| | | | | Colloids and Surfaces A: |
| | | | | Physicochemical and Engineering |
| | | | | Aspects, 2019, 561: 236-243. |
| co-pyrolyzed | pH = 5.5 | 100 | 30.62 | The present invention |
| sludge | T = 25° C. | | | |
| biochar | | | | |
| modified by | | | | |
| lanthanum | | | | |
| carbonate | | | | |

Although the embodiments of the present invention have been published as above, they are not limited to the applications listed in the specification and embodiments. They can completely be applied to various fields suitable for the present invention. For those skilled in the art, additional amendments can be easily achieved, therefore, without departing from the general concept defined by the claims and the equivalent scope, the present invention is not limited to the specific details and the illustrations shown and described here.

1. A preparation method of co-pyrolyzed sludge biochar modified by lanthanum carbonate, characterized in that, it comprises the following steps:
adding a co-pyrolyzed sludge biochar into a metal salt solution of lanthanum ions, heating and adding a carbonate solution until the pH is 8 to 9, standing still at a constant temperature, and separating to obtain the co-pyrolyzed sludge biochar modified by lanthanum carbonate, the co-pyrolyzed sludge biochar is prepared by co-pyrolysis of sludge and bamboo.

2. The preparation method according to claim 1, characterized in that, the preparation method of the co-pyrolyzed sludge biochar comprises: mixing bamboo and sludge at a mass ratio of 1:1, crushing with a pulverizer for 5 to 10 minutes, filtering through a sieve of 80 to 200 meshes, and pyrolyzing to obtain the co-pyrolyzed biochar.

3. The preparation method according to claim 2, characterized in that, the pyrolysis comprises heating to 600° C. at a heating rate of 10 to 15° C./hour, maintaining at a constant temperature of 600° C. for 1 hour, and then cooling to room temperature.

4. The preparation method according to claim 1, characterized in that, a concentration of lanthanum ions in the metal salt solution is 0.1 to 0.5 mol/L.

5. The preparation method according to claim 1, characterized in that, the metal salt solution of lanthanum ions is obtained by dissolving lanthanum nitrate hexahydrate in water and stirring for 2 hours to 6 hours.

6. The preparation method according to claim 4, characterized in that, the ratio of the amount of the co-pyrolyzed sludge biochar to lanthanum ions is 100 g:1 mol.

7. The preparation method according to claim 1, characterized in that, the temperature for the heating is 30 to 50° C., the stirring rate is 400 to 800 rpm/min, the carbonate solution is a sodium carbonate solution with a concentration of 1 mol/L, and the standing still is standing still at 40 to 60° C. for 6 to 12 hours.

8. The preparation method according to claim 1, characterized in that, the separating is washing for 3 to 5 times, centrifuging the solution at 3000 to 5000 rpm/min for 5 to 10 minutes, filtering, and drying at 40 to 60° C. for 36 to 48 hours.

9. A co-pyrolyzed sludge biochar modified by lanthanum carbonate prepared by the method according to claim 1.

10. Use of the co-pyrolyzed sludge biochar modified by lanthanum carbonate according to claim 9 for adsorption of phosphate in water.
